(19) United States
(12) Patent Application Publication
(10) Pub. No.: US 2005/0123804 A1
(43) Pub. Date: Jun. 9, 2005

(54) Optical recording materials having high storage density

(76) Inventors: Leonhard Feiler, Neuenburg (DE); Beat Schmidhalter, Bubendorf (CH); Jean-Luc Budry, Rossemaison (CH); Urs Lehmann, Basel (CH)

Correspondence Address: CIBA SPECIALTY CHEMICALS CORPORATION;PATENT DEPARTMENT, 540 WHITE PLAINS RD, P O BOX 2005, TARRYTOWN, NY, 10591-9005, US

(21) Appl. No.: 10/502,207

(22) PCT Filed: Jan. 25, 2002
(86) PCT No.: PCT/EP03/00484

(30) Foreign Application Priority Data
Jan. 25, 2002 (CH) 2002 126/02

(51) Int. Cl. B32B 9/00; B32B 19/00

(52) U.S. Cl. 428/694 ML; 428/694 SC; 428/694 DE; 428/694 RL; 428/694 ST; 428/694 SL; 428/692

(57) ABSTRACT

The invention relates to an optical recording medium comprising a substrate, a recording layer and a reflecting layer, wherein the recording layer comprises a compound of formula (I), (II), (III), (IV), (V) or a tautomer or a salt thereof. For the precise definitions of the substituents, reference is made to the description. Recording and playback are carried out especially at a wavelength of from 350 to 500 nm, for example using a blue laser. The recording and playback quality is excellent and allows high storage density. Also claimed are optical recording media for recording or playing back at from 380 to 440 nm that comprise a compound having an absorption maximum in the wave range from 300 to 400 nm and a compound of formula (IX).

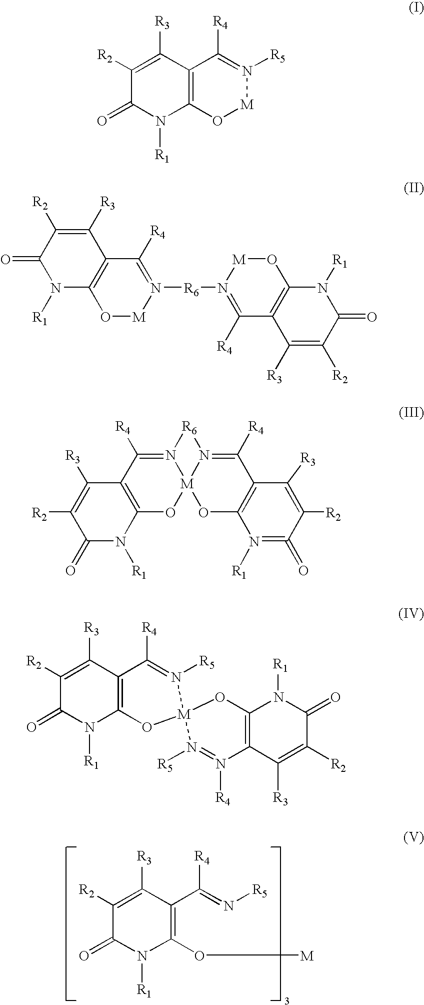

The invention relates to novel optical recording materials that have an excellent recording and playback quality, especially at a wavelength of from 350 to 500 nm. Recording and playback can very advantageously take place at the same wavelength, and the storage density achievable is appreciably higher than in the case of known materials. In addition, the materials according to the invention have very good storage properties before and after recording, even under harsh conditions, such as exposure to sunlight or fluorescent tube light, to heat and/or to high humidity. They can, moreover, be produced simply and with good reproducibility using customary coating methods, such as spin coating. Many of the compounds used in the materials according to the invention are furthermore free of heavy metals, thus substantially facilitating recycling of the metallic reflector layer of, for example, white gold, silver or aluminium.

J. Inf. Recording 25, 69-86 [2000] discloses merocyanine dyes of formula 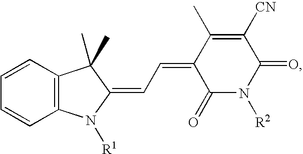
which can be prepared from the starting material of formula 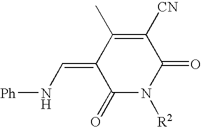
(wherein, for example, R²=Hex) and may be used in composite plastics for photoluminescent and photorefractive applications. According to that publication, the sterically hindered 3,3-dimethylmethylene group in the five-membered ring is of special importance in preventing crystallisation and in making amorphous glasses possible; however, when used in electrooptical applications, it is not possible to apply known principles of design.

JP-A-10/273484 describes optical recording media comprising azomethine metal chelates of formula 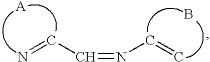
for example such a medium comprising the compound of formula 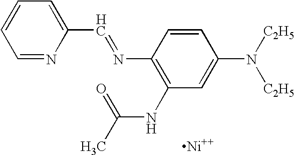
having an absorption maximum λₘₐₓ at 488 nm, on which recording is carried out at 635 nm. JP-A-11/334204 describes optical recording media comprising monoazo compounds of the basic structure 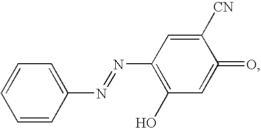
for example the compound of formula 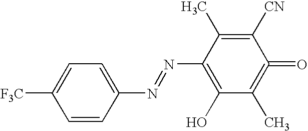
having an absorption maximum λₘₐₓ at 439 nm, on which recording is carried out at 488 nm. That wavelength still is higher than desired; in addition, such optical media have low sensitivity and their higher wavelength absorption flank is not sufficiently steep, with the result that the recordings leave something to be desired in respect of the high demands made in terms of quality.

JP-A-2000/163,799 describes optical recording media comprising barbituric acid derivatives of formula 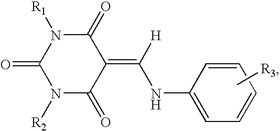
for example comprising the compound of formula 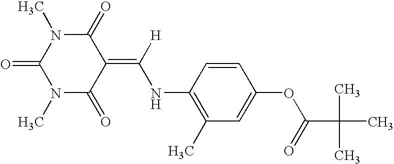
having an absorption maximum λₘₐₓ at 339.5 nm, on which recording is carried out at 420 nm. Likewise, however, those optical media have low sensitivity and their higher wavelength absorption flank is not sufficiently steep, and so the results in practice are in no way satisfactory.

EP-A-1 083 555 describes optical recording media comprising compounds of formula 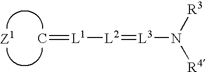
for example those of formula 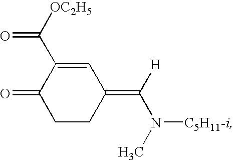
on which recording is carried out at 550 nm or at a shorter wavelength, but those optical media likewise produce results that are not entirely satisfactory.

WO-01/75873 discloses optical recording media for the range from 360 to 460 nm, but does not provide any practical examples. The very many compounds listed also include compounds of formula

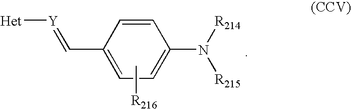

Known optical recording materials therefore meet the high requirements only in part or do not meet all requirements simultaneously with entire satisfaction.

JP-A-11/34500 discloses the use of metal complex dyes in optical recording materials, including the following heterocyclic compounds which, however, have an absorption maximum λₘₐₓ above 500 nm with very low absorption:

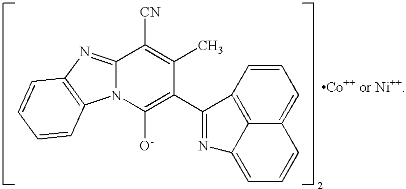

The invention is directed at an optical recording medium having high information density and high data reliability. That recording medium should be robust, durable and simple to use. In addition it should be cheap to produce on a large scale, require apparatuses that are as small and as inexpensive as possible, and contain as little as possible in the way of environmentally harmful substances, such as volatile or toxic metals, or at least allow easy disposal of such environmentally harmful substances.

The invention accordingly relates to an optical recording medium comprising a substrate, a recording layer and a reflecting layer, wherein the recording layer comprises a compound of formula 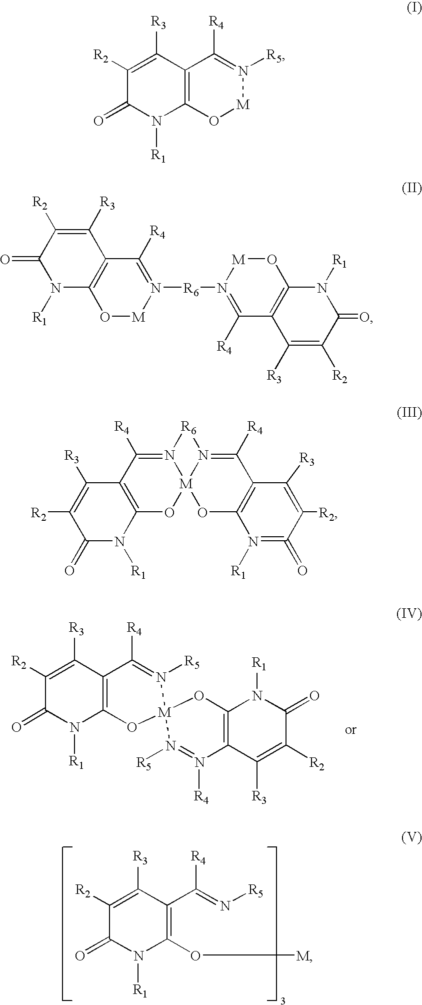
or a tautomer or a salt thereof, if desired in ionised form in the form of a salt neutralised with a counter-ion, wherein
R₁ is hydrogen or is C₁-C₂₄alkyl, C₁-C₄alkyl-[O—C₂-C₄alkylene]ₘ, C₁-C₄alkyl-[NH—C₂-C₄-alkylene]ₘ, C₂-C₂₄alkenyl, C₃-C₂₄cycloalkyl, C₃-C₂₄cycloalkenyl, C₆-C₁₂aryl, C₄-C₁₂heteroaryl or C₇-C₁₂aralkyl each of which is unsubstituted or substituted by one or more optionally identical or different R₇ radicals;
R₂ and R₃ are each independently of the other hydrogen, NO₂, CO—R₈, COOH, COOR₈, CONR₉R₁₀, CN, SO₃R₈ or SO₂NR₉R₁₀, or 1-C₂₄alkyl, C₁-C₄alkyl-[O—C₂-C₄alkylene]ₘ, C₁-C₄alkyl-[NH—C₂-C₄alkylene]ₘ, C₂-C₂₄alkenyl, C₃-C₂₄cycloalkyl, C₃-C₂₄cycloalkenyl, C₆-C₁₂aryl, C₄-C₁₂heteroaryl or C₇-C₁₂aralkyl each of which is unsubstituted or substituted by one or more optionally identical or different R₇ radicals;
it being possible for R₃ to be so linked to R₂ that a 5- or 6-membered ring is formed;
R₄ is hydrogen or is C₁-C₂₄alkyl, C₁-C₄alkyl-[O—C₂-C₄alkylene]ₘ, C₁-C₄alkyl-[NH—C₂-C₄-alkylene]ₘ, C₂-C₂₄alkenyl, C₃-C₂₄ cycloalkyl, C₃-C₂₄cycloalkenyl, C₆-C₁₂aryl, C₄-C₁₂heteroaryl or C₇-C₁₂aralkyl each of which is unsubstituted or substituted by one or more optionally identical or different R₇ radicals;
it being possible for R₄ to be so linked to R₃ that a 5- or 6-membered ring is formed;
R₅ is R₆H, C₆-C₁₂aryl, C₄-C₁₂heteroaryl or C₇-C₁₂aralkyl each of which is unsubstituted or substituted by one or more optionally identical or different R₇ radicals;
it being possible for R₅ to be so linked to R₄ that a 5- or 6-membered ring is formed;
R₆ is a group selected from the series consisting of —N═N—, —O—, —S—, —SO₂—, —CH═N—, and of 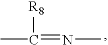
   C₁-C₂₄alkylene, C₁-C₄alkylene-[O—C₂-C₄alkylene]ₘ, C₁-C₄alkylene-[NH—C₂-C₄-alkylene]ₘ, C₂-C₂₄alkenylene, C₃-C₂₄cycloalkylene, C₃-C₂₄cycloalkenylene, C₆-C₁₂aryl, C₄-C₁₂heteroarylene and C₇-C₁₂aralkylene each of which is unsubstituted or substituted by one or more optionally identical or different R₇ radicals; or is a sequence of a plurality of such groups;
R₇, and where appropriate a plurality of R₇ radicals, each independently of any other, is halogen, OH, O—R₈, O—CO—R₈, S—R₈, NH₂, NH—R₈, NR₉R₁₀, NR₈—CO—R₉, NR₉COOR₈, CHO, carboxy, carbamoyl, ureido, NR₉—CO—NHR₁₀, phosphato, PRGR₁₀, POR₈OR₉, P(═O)OR₈OR₉, OPR₈R₉, OPR₈OR₉, OP(═O)R₈OR₉, OP(═O)OR₈OR₉ OPO₃R₈, sulfato, sulfo, NO₂, CO—R₈, COOH, COOR₈, CONR₉R₁₀, CN, SO₃R₈ or SO₂NR₉R₁₀, or is C₁-C₁₂alkyl unsubstituted or mono- or poly-substituted by hydroxy, CO—R₈, COOH, COOR₈ CONR₉R₁₀ or by halogen;
R₈, R₉ and R₁₀ are each independently of the others C₁-C₁₂alkyl, C₂-C₁₂alkenyl, C₆-C₁₂aryl, C₄-C₁₂heteroaryl or C₇-C₁₂aralkyl; or
R₉ and R₁₀, together with the common nitrogen, are unsubstituted or with C₁-C₄alkyl mono- to tetra-substituted pyrrolidine, piperidine, piperazine or morpholine;
m is a number from 1 to 10; and
M is hydrogen or an alkali metal, alkaline earth metal or transition metal that may or may not have one or more ligands.

When R₅ is C₆-C₁₂aryl, then 1 or 2 R₇ radicals are especially in the ortho position; an R₇ radical in the ortho position to which special preference is given is halogen, CHO, NO₂, CO—R₈, COOH, COOR₈, CONR₉R₁₀, CN or C₁-C₁₂alkyl, more especially halogen (for example fluorine, chlorine or bromine) or C₁-C₁₂alkyl unsubstituted or mono- or poly-substituted by hydroxy, CO—R₈, COOH, COOR₈, CONR₉R₁₀ or by halogen.

When a compound of formula (I), (II), (III), (IV) or (V) is a salt, the counter-ion may advantageously be an inorganic, organic or oranometallic counter-ion in the stoichiometry necessary for balancing the charge, for example the anion of a mineral acid, (for example an alcoholate, phenylate, carboxylate, sulfonate or phosphonate), the conjugate base of an organic acid or an organometallic complex anion, for example fluoride, chloride, bromide, iodide, perchlorate, periodate, cyanide, cyanate, isocyanate, thiocyanate, isothiocyanate, azide, nitrate, ½ carbonate, hydrogen carbonate, C₁-C₄alkyl sulfate, ½ sulfate, hydrogen sulfate, monoalkali metal sulfate, methanesulfonate, trifluoromethanesulfonate, tosylate, ⅓ phosphate, ½ monoalkali metal phosphate, dialkali metal phosphate, ½ hydrogen phosphate, dihydrogen—phosphate, hexafluorophosphate, hexafluoroantimonate, ½C₁-C₄alkane phosphonate, C₁-C₄alkane-C₁-C₁₂alkyl phosphonate, di-C₁-C₄alkyl phosphinate, tetraphenyl borate, tetrafluoroborate, benzenesulfonate, p-chlorobenzenesulfonate, p-nitrobenzene-sulfonate, benzoate, acetate, trifluoroacetate, heptafluorobutyrate, ½ oxalate or another carboxylate, an alcoholate, phenylate (e.g. phenylate itself), or a negatively charged metal complex, or a cation, such as H⁺, Li⁺, K⁺, Na⁺, Mg⁺², Ca⁺², Sr⁺², Al⁺³ or primary, secondary, tertiary or quaternary ammonium, for example [NR₁₁R₁₂R₁₃R₁₄]⁺ wherein R₁₁ to R₁₄, each independently of R₁ to R₄, may be further radicals R₁ to R₄, preferably H or C₁-C₂₄alkyl, C₁-C₂₄alkenyl, C₃-C₂₄cycloalkyl, C₁-C₂₄aralkyl or C₆-C₁₀aryl, which may be unsubstituted or hydroxy-substituted and optionally interrupted one or more times by oxygen, or an ammonium or phosphonium cation, for example ammonium, methylammonium, ethylammonium, isopropylammonium, pentadecyl-ammonium, dicyclohexylammonium, tetramethylammonium, tetraethylammonium, tetrabutylammonium, benzyltrimethylammonium, benzyltriethylammonium, methyltrioctylammonium, tridodecylmethylammonium, tetrabutylphosphonium, tetraphenylphosphonium, butyltriphenylphosphonium or ethyltriphenylphosphonium.

It is also possible to influence the solubility in a manner known per se by means of the counter-ion. For example, the solubility in solvents of low and medium polarity, such as ethers, alcohols or ketones, can be increased by the selection of tetra-n-butyl-ammonium or Primene® 81-R (Rohm & Haas) as the counter-ion, and the solubility in very polar and hydrophilic solvents can be increased by the selection of tris-2-hydroxyethylammonium as the counter-ion.

Phenylates or carboxylates are, for example, anions of C₁-C₁₂-alkylated, especially tert-C₄-C₈-alkylated, phenols and benzoic acids, such as

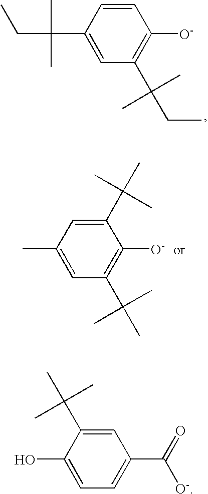

The person skilled in the art will readily recognise that it is also possible to use other counter-ions with which he is familiar. A multi-charged counter-ion is able to neutralise a plurality of singly charged cations or anions or one multi-charged cation or anion, as the case may be, it also being possible, for example, for dimers to be formed.

M as a metal may be, for example, Li⁺, Na⁺, K⁺, Mg²⁺, Ca²⁺, Sr²⁺, Ba²⁺, Al³⁺, Ce³⁺, Cu⁺, Cu²⁺, Ni²⁺, Fe²⁺, Fe³⁺, Co²⁺, Co³⁺, Co⁴⁺, Zn²⁺, Pt²⁺, Pd²⁺, Sn²⁺, Sn⁴⁺, La³⁺, Ag⁺, Au⁺, Au³⁺, Mn⁺, Mn²⁺, Ru²⁺, Ru³⁺, Os³⁺, Os³⁺, Si⁴⁺, Ti⁴⁺ or V⁵⁺. Preferred as M are Cu²⁺, Ni²⁺ and Co³⁺, and also hydrogen is of special interest.

When M is a metal, it will be understood that it is also possible for one or more additional ligands to be present, for example water, ammonia or any primary, secondary or tertiary amine, an alcohol, an ether, a mercaptan, a thiol, a heterocyclic ligand, such as pyrrole, imidazole, pyrazole, pyridine, pyrazine, pyrimidine, pyridazine, indole, isoindole, indolizine, indazole, purine, quinolizine, quinoline, isoquinoline, 1,8-naphthyridine, phthalazine, quinoxaline, quinazoline, cinnoline, pteridine, carbazole, β-carboline, acridine, phenanthridine, perimidine, 1,7-phenanthroline, phenazine, phenarsazine, phenothiazine, phenoxazine, oxazole, isoxazole, phosphindole, thiazole, isothiazole, furazan, pyrrolidine, piperidine, 2-pyrroline, 3-pyrroline, imidazolidine, 2-imidazoline, 4-imidazoline, pyrazolidine, 2-pyrazoline, 3-pyrazoline, piperazine, indoline, isoindoline, quinuclidine, morpholine, 1,2,3-triazole, 1,2,4-triazole, benzotriazole, phosphinoline and phosphindoline, which may be unsubstituted or substituted, or any other desired solvent, either in neutral form or in mono- or poly-deprotonated form. The bonding character varies according to ligand and metal, as, for example, in Fe(III)Cl, Ti(IV)O and V(V)O. In metals suitable for that purpose it is also possible for covalent substituents to be present instead of ligands, for example C₁-C₂₄alkyl, C₆-C₁₂aryl or C₇-C₁₂aralkyl in the case of silanes.

Halogen is chlorine, bromine, fluorine or iodine, preferably flourine or chlorine, especially fluorine on alkyl (for example trifluoromethyl, α,α,α-trifluoroethyl or perfluorinated alkyl groups, such as heptafluoropropyl) and chlorine on aryl, heteroaryl or on the aryl moiety of aralkyl.

Alkyl or alkenyl, for example C₁-C₂₀alkyl, or C₂-C₂₀alkenyl, may be straight-chain or branched. Cycloalkyl or cycloalkenyl may be straight-chain or branched, monocyclic or polycyclic. C₁-C₂₄Alkyl may accordingly be, for example, methyl, ethyl, n-propyl, isopropyl, n-butyl, sec-butyl, isobutyl, tert-butyl, 2-methylbutyl, n-pentyl, 2-pentyl, 3-pentyl, 2,2-dimethylpropyl, n-hexyl, heptyl, n-octyl, 1,1,3,3-tetramethylbutyl, 2-ethylhexyl, nonyl, decyl, undecyl, dodecyl, tridecyl, tetradecyl, pentadecyl, hexadecyl, heptadecyl, octadecyl, nonadecyl, eicosyl, heneicosyl, docosyl or tetracosyl.

Substituted alkyl is substituted, for example, by halogen, hydroxy or by alkoxy; mention may be made especially of trifluoromethyl and 3-isopropyloxy-propyl and also homologous groups thereof.

C₃-C₂₄Cycloalkyl may accordingly be, for example, cyclopropyl, cyclopropylmethyl, cyclobutyl, cyclopentyl, cyclohexyl, cyclohexylmethyl, trimethylcyclohexyl, thujyl, norbornyl, bornyl, norcaryl, caryl, menthyl, norpinyl, pinyl, 1-adamantyl, 2-adamantyl, 5α-gonyl, 5ξ-pregnyl, (+)-1,3,3-trimethylbicyclo[2.2.1]heptyl (fenchyl) or, where they exist, optical isomers thereof.

C₂-C₂₀Alkenyl and C₃-C₂₀cycloalkenyl are C₂-C₂₀alkyl and C₃-C₂₀cycloalkyl respectively, each of which may be mono- or poly-unsaturated and in which two or more double bonds may optionally be isolated or conjugated. C₂-C₂₄Alkenyl is accordingly, for example, vinyl, allyl, 2-propen-2-yl, 2-buten-1-yl, 3-buten-1-yl, 1,3-butadien-2-yl, 2-penten-1-yl, 3-penten-2-yl, 2-methyl-1-buten-3-yl, 2-methyl-3-buten-2-yl, 3-methyl-2-buten-1-yl, 1,4-pentadien-3-yl, or any isomer of hexenyl, octenyl, nonenyl, decenyl, dodecenyl, tetradecenyl, hexadecenyl, octadecenyl, eicosenyl, heneicosenyl, docosenyl, tetracosenyl, hexadienyl, octadienyl, nonadienyl, decadienyl, dodecadienyl, tetradecadienyl, hexadecadienyl, octadecadienyl or eicosadienyl. C₃-C₂₄Cycloalkenyl is, for example, 2-cyclobuten-1-yl, 2-cyclopenten-1-yl, 2-cyclohexen-1-yl, 3-cyclohexen-1-yl, 2,4-cyclohexadien-1-yl, 1-p-menthen-8-yl, 4(10)-thujen-10-yl, 2-norbornen-1-yl, 2,5-norbornadien-1-yl, 7,7-dimethyl-2,4-norcaradien-3-yl or camphenyl.

C₇-C₁₈Aralkyl is, for example, benzyl, 2-benzyl-2-propyl, β-phenyl-ethyl, 9-fluorenyl, α,α-dimethylbenzyl, ω-phenyl-butyl, ω-phenyl-octyl, ω-phenyl-dodecyl or 3-methyl-5-(1′,1′,3′,3′-tetramethylbutyl)-benzyl. C₇-C₂₄Aralkyl may in additon also be, for example, 2,4,6-tri-tert-butylbenzyl or 1-(3,5-dibenzylphenyl)-3-methyl-2-propyl. When C₇-C₁₈aralkyl is substituted, substitution may be either on the alkyl moiety or on the aryl moiety of the aralkyl group, the latter alternative being preferred.

C₆-C₁₄Aryl is, for example, phenyl, naphthyl, biphenylyl, 2-fluorenyl, phenanthryl, anthracenyl or terphenylyl.

C₄-C₁₂Heteroaryl is an unsaturated or aromatic free radical having 4n+2 conjugated π-electrons, for example 2-thienyl, 2-furyl, 2-pyridyl, 2-thiazolyl, 2-oxazolyl, 2-imidazolyl, isothiazolyl, triazolyl or any other desired ring system that comprises thiophene, furan, pyridine, thiazole, oxazole, imidazole, isothiazole, triazole, pyridine and benzene rings and that is unsubstituted or substituted by from 1 to 6 ethyl, methyl, ethylene and/or methylene groups.

In addition, aryl and aralkyl may also be aromatic groups bonded to a metal, for example in the form of metallocenes, known per se, of transition metals, more especially

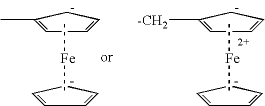

Preference is given to compounds of formula (I), (II), (i), (IV) or (V) wherein R₁ is unsubstituted or monosubstituted C₁-C₁₂alkyl, R₂ is COOR₈, CONR₉R₁₀ or, especially, CN, R₃ is hydrogen or, especially, C₁-C₄alkyl, R₄ is C₁-C₄alkyl or, especially, hydrogen, and/or R₅ is C₆-C₁₂aryl unsubstituted or substituted by one or more optionally identical or different R₇ radicals. Special preference is given to compounds of formula (I), (II), (III) or (IV) wherein R₁ is C₁-C₄alkyl, especially methyl or ethyl, R₂ is CN, R₃ is methyl and R₄ is hydrogen. Very special preference is given to compounds of formula (I) or (II), especially those of formula 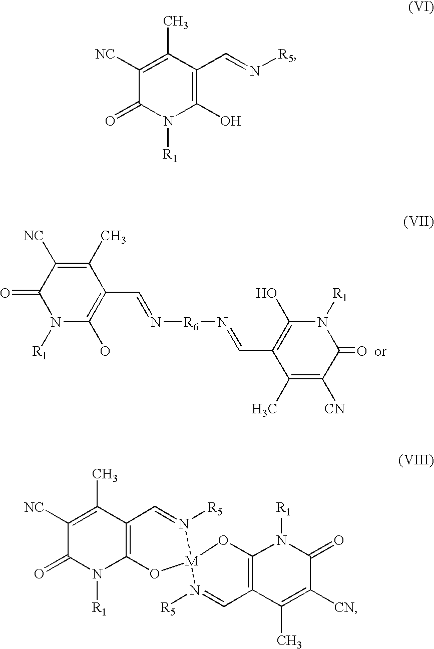
wherein M′ is a transition metal.

When R₆ is a sequence of a plurality of groups, the number thereof is preferably 2 or 3, groups bonded directly to one another preferably being different.

The recording layer preferably comprises a compound of formula (I), (II), (III), (IV) or (V) or a mixture of such compounds as the main component, for example at least 20% by weight, especially at least 50% by weight, more especially at least 80% by weight. Further customary constituents are possible, for example other chromophores (for example those having an absorption maximum at from 300 to 1000 nm), stabilisers, free radical capture agents (for example for ¹O₂), or luminescence quenchers, melting point reducers, decomposition accelerators, or any other additives that have already been described in optical recording media.

When the recording layer comprises further chromophores, such chromophores may in principle be any dyes that can be decomposed or modified by the laser radiation during the recording, or that may be inert towards the laser radiation. When the further chromophores are decomposed or modified by the laser radiation, this can take place directly by absorption of the laser radiation or can be induced indirectly by the decomposition of the compounds of formula (I), (II), (III), (IV) or (V) according to the invention, for example thermally.

It will be understood that further chromophores or coloured stabilisers may influence the optical properties of the recording layer. It is therefore preferable to use further chromophores or coloured stabilisers, the optical properties of which conform as far as possible to, or are as different as possible from, those of the compounds of formula (I), (II), (III), (IV) or (V), or the amount of further chromophores is kept small.

Examples thereof are UV absorbers that are hypsochromic to the dye of formula (I), (II), (III), (IV) or (V), or coloured stabilisers that are bathochromic to the dye of formula (I), (II), (III), (IV) or (V) and have absorption maxima lying, for example, in the NIR or IR range. Other dyes can also be added for the purpose of colour-coded identification, colour-masking (“diamond dyes”) or enhancing the aesthetic appearance of the recording layer.

When further chromophores having optical properties that conform as far as possible to those of compounds of formula (I), (II), (III), (IV) or (V) are used, preferably this should be the case in the range of the longest-wavelength absorption flank. Preferably the wavelengths of the inversion points of the further chromophores and of the compounds of formula (I), (II), (III), (IV) or (V) are a maximum of 40 nm, especially a maximum of (II), (III), (IV) or (V) should exhibit similar behaviour in respect of the laser radiation, so that it is possible to use as further chromophores known recording compositions the action of which is synergistically enhanced or heightened by the compounds of formula (I), (II), (III), (IV) or (V).

When further chromophores or coloured stabilisers having optical properties that are as different as possible from those of compounds of formula (I), (II), (III), (IV) or (V) are used, they advantageously have an absorption maximum that is hypsochromically or bathochromically shifted relative to the dye of formula (I), (II), (III), (IV) or (V). In that case the absorption maxima are preferably at least 50 nm, especially at least 100 nm, apart.

When another dye is added in order to modify the optical properties of the compounds of formula (I), (II), (III), (IV) or (V), the amount thereof is dependent upon the optical properties to be achieved. The person skilled in the art will find little difficulty in varying the ratio of additional dye to compound of formula (I), (II), (III), (IV) or (V) until he obtains the result he desires.

When chromophores or coloured stabilisers are used for other purposes, the amount thereof should preferably be small so that their contribution to the total absorption of the recording layer in the range of from 350 to 450 nm is a maximum of 20%, preferably a maximum of 10%. In such a case, the amount of additional dye or stabiliser is advantageously a maximum of 50% by weight, preferably a maximum of 10% by weight, based on the recording layer.

Especially preferably, however, no additional chromophore is added unless it is a coloured stabiliser.

Further chromophores that can be used in the recording layer, in addition to the compounds of formula (I), (II), (III), (IV) or (V), are, for example, cyanines and cyanine metal complexes (U.S. Pat. No. 5,958,650), styryl compounds (U.S. Pat. No. 6,103,331), oxonol dyes (EP-A-833 314), azo dyes and azo metal complexes (JP-A-11/028865), phthalocyanines (EP-A-232 427, EP-A-337 209, EP-A-373 643, EP-A-463 550, EP-A-492 508, EP-A-509 423, EP-A-511 590, EP-A-513 370, EP-A-514 799, EP-A-518 213, EP-A-519 419, EP-A-519 423, EP-A-575 816, EP-A-600 427, EP-A-676 751, EP-A-712 904, WO-98/14520, WO-00/09522, CH-693/01), porphyrins, dipyrromethene dyes and metal chelate compounds thereof (EP-A-822 544, EP-A-903 733), xanthene dyes and metal complex salts thereof (U.S. Pat. No. 5,851,621) or quadratic acid compounds (EP-A-568 877), also oxazines, dioxazines, diazastryrls, formazans, anthraquinones or phenothiazines or other porphyrazines (EP-A-822 546, U.S. Pat. No. 5,998,093, JP-A-2001/277723); this list is on no account exhaustive and the person skilled in the art will interpret the list as including further known dyes, for example those disclosed in CH 2001 519/01 or CH 2001 2102/01.

When the recording layer contains further chromophores, the amount of those chromophores should preferably be so small that the absorption thereof at the wavelength of the inversion point of the longest-wavelength flank of the absorption of the solid layer as a whole is, at the same wavelength, a fraction, advantageously no more than ⅓, especially no more than ⅕, more especially no more than 1/10, of the absorption of the pure compound of formula (I), (II), (E), (IV) or (V) in the solid layer as a whole. The absorption maximum is preferably higher than 425 nm, especially higher than 500 nm.

Stabilisers or luminescence-quenchers are, for example, metal complexes of N- or S-containing enolates, phenylates, bisphenylates, thiolates or bisthiolates or of azo, azomethine or formazan dyes, such as ®Irgalan Bordeaux EL (Ciba Specialty Chemicals Inc.), ®Cibafast N (Ciba Specialty Chemicals Inc.) or similar compounds, hindered phenyls and derivatives thereof (optionally also as counter-ions X), such as ®Cibafast AO, o-hydroxyphenyl-triazoles or -triazines or other UV absorbers, such as ®Cibafast W or ®Cibafast P or hindered amines (TEMPO or HALS, also as nitroxides or NOR-HALS, optionally also as counter-ions X), and also, as cations, diimmonium, Paraquat™ or Orthoquat™ salts, such as ®Kayasorb IRG 022 or ®Kayasorb IRG 040. ®Irgalan and ®Cibafast brands are from Ciba Specialty Chemicals Inc., ®Kayasorb brands from Nippon Kayaku Co. Ltd.

Many such structures are known, some of them also in connection with optical recording media, for example from U.S. Pat. No. 5,219,707, JP-A-06/199045, JP-A-07/76169 or JP-A-07/262,604. They may also be, for example, salts of metal complex anions with any desired cations, for example the cations disclosed in U.S. Pat. No. 5,851,621 or U.S. Pat. No. 6,228,911.

Also suitable are neutral metal complexes, for example those disclosed in CH 2001 519/01 or CH 2001 2102/01 and to which reference is expressly made herein.

Particular examples of such metal complex additives that may be mentioned are copper complexes, illustrated e.g. by a compound of formula

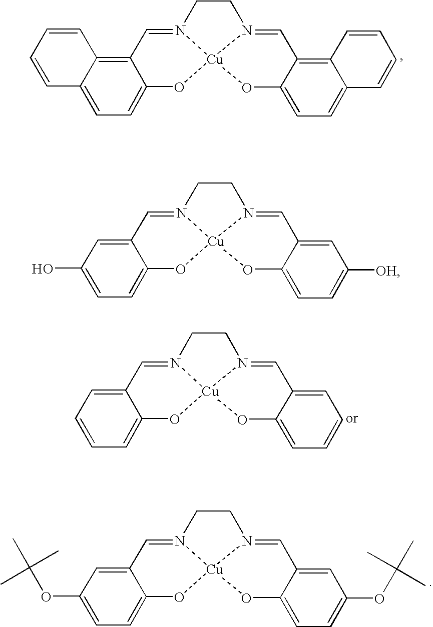

There may also be mentioned especially nickel bisphenylates, illustrated, for example, by the compound of formula

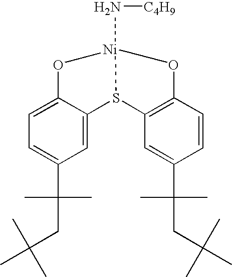

As an additive for the compounds of formula (I), (II), (III), (IV) or (V) according to the invention, as well as quite generally for any other dyes in optical media that are written or played back at from 380 to 440 nm, preference is given, inter alia, to the azometal complex anion of formula (DC) hereinbelow, which has an absorption minimum at approximately from 405 to 410 nm, in the form of a counter-ion or in the form of a salt.

The invention accordingly relates also to an optical recording medium comprising a substrate, a recording layer and a reflecting layer, wherein the optical recording medium is suitable for recording or playback in the wave range from 380 to 440 nm and the recording layer comprises a compound having an absorption maximum in the wave range from 300 to 400 nm and also a compound of formula 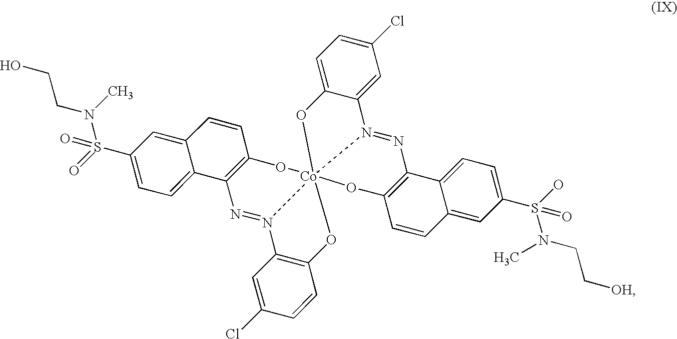
which may be unsubstituted or substituted and/or may be in isomeric form.

Additional substituents and/or isomerism may advantageously be present in the case of formula (IX), provided that the compounds in question have equivalent optical properties, for example an absorption maximum λₘₐₓ, in dimethylformamide, that differs from the absorption maximum λₘₐₓ of the compound of the exact formula (IX) by a maximum of ±10 nm, preferably a maximum of ±5 nm. The compound is, however, more especially of the exact formula (IX).

The person skilled in the art will know from other optical information media, or will readily recognise, which additives in which concentration will be especially well suited for which purpose. Suitable concentrations of additives are, for example, from 0.001 to 1000% by weight, preferably from 1 to 50% by weight, based on the recording agent of formula (I), (II), (III), (IV) or (V).

The optical recording materials according to the invention exhibit excellent spectral properties of the solid amorphous recording layer. Owing to a surprisingly low tendency of such compounds to aggregate in the solid material, the absorption band is narrow and intense, having an especially high degree of steepness on the long-wavelength side. Unexpectedly, and very advantageously, dimers are not formed or are formed only to a negligible extent. The reflectivity of the layers in the region of the writing and reading wavelength is high in the unwritten state.

Owing to those excellent layer properties, a rapid optical recording having a high degree of sensitivity, high level of reproducibility and geometrically very precise pit boundaries is possible, the refractive index and the reflectivity being substantially modified, resulting in a high level of contrast. The tolerances on the pit lengths and gap distances (“jitter”) are very small. This allows a high storage density as a result of a comparatively thin recording channel with a relatively small track separation (“pitch”). In addition, the recorded data is played back with astonishingly low error rates, with the result that error correction requires only a small amount of storage space.

As a result of the excellent solubility, even in apolar solvents, it is also possible to use solutions of high concentration without troublesome precipitation occurring, for example during storage, so that problems during spin coating largely disappear.

Recording and playback can be carried out at the same wavelength. Advantageously, a simple lens with a single laser source of, advantageously, from 350 to 500 nm, especially up to 480 nm, preferably from 370 to 450 nm, is therefore used. The wavelength is especially preferably in the UV range from 370 to 390 nm, especially approximately 380 nm, or especially at the margin of the visible range from 390 to 430 nm, especially approximately 405±5 nm. In the range of compact, blue or violet laser diodes (such as Nichia GaN 405 nm) with a lens having a high numerical aperture, it is possible for the pits to be so small and the tracks so narrow that up to approximately 20 to 25 Gb per recording layer can be achieved on a 120 mm disc. At 380 nm, it is possible to use indium-doped UV-VCSELs (Vertical-Cavity Surface-Emitting Laser); such a laser source already exists as a prototype [Jung Han et al., cf. MRS Internet J. Nitride Semicond. Res. 5S1, W6.2 (2000)]. In addition it is also known to produce wavelengths of from 350 to 500 nm by means of conversion of the second harmonic oscillation of a laser source of higher wavelength, for example a laser source of a wavelength of from 700 to 1000 nm.

The invention accordingly relates also to a method for the recording or playback of data that comprises recording or playing back the data at a wavelength of from 350 to 500 nm on an optical recording medium according to the invention.

The recording medium is based on the structure of known recording media and may, for example, be constructed from a transparent substrate; a recording layer comprising at least one of the compounds of formula (I), (II), (III), (IV) or (V); a reflector layer; and a covering layer, the writing and reading being carried out through the substrate.

Suitable substrates include, for example, glasses, minerals, ceramics and thermosetting or thermoplastic plastics. Preferred supports are glasses and homo- or co-polymeric plastics. Suitable plastics include, for example, thermoplastic polycarbonates, polyamides, polyesters, polyacrylates and polymethacrylates, polyurethanes, polyolefins, polyvinyl chloride, polyvinylidene fluoride, polyimides, thermosetting polyesters and epoxy resins. Special preference is given to polycarbonate substrates, which can be produced, for example, by means of injection-moulding. The substrate may be in pure form or may also comprise customary additives, for example UV absorbers or dyes, as proposed, for example, in JP-A-04/167239 as light stabilisation for the recording layer. In the latter case, it may be advantageous that the dye added to the supporting substrate exhibits no absorption or at most a small amount of absorption in the range of the writing wavelength (emission wavelength of the laser), preferably up to a maximum of approximately 20% of the laser light focussed onto the recording layer.

Advantageously, in that case the substrate is transparent over at least a portion of the range from 350 to 500 nm, so that it is permeable to, for example, at least 80% of the light of the writing or reading wavelength incident thereon. The substrate advantageously has a thickness of from 10 μm to 2 mm, especially from 100 to 1200 μm, more especially from 600 to 1100 μm, with a preferably spiral-shaped guide groove (track) on the coating side, a groove depth of from 10 to 200 nm, preferably from 80 to 150 nm, a groove width of from 100 to 400 nm, preferably from 150 to 250 nm, and a spacing between 2 revolutions of from 200 to 600 nm, preferably from 350 to 450 nm. Grooves of various cross-sectional profiles are known, for example rectangular, trapezium-shaped or V-shaped. Analogously to the known CD-R and DVD-R media, the guide groove may, in addition, undergo a small periodic or quasi-periodic lateral deflection (“wobble”), allowing synchronisation of the speed of rotation and absolute positioning of the reading head (“pick-up”). The same function can be performed, instead of or in addition to the deflection, by markings between adjacent grooves (“pre-pits”).

The recording composition is applied, for example, by spin-coating a solution, the intention being to provide a layer that is as amorphous as possible, the thickness of which on the surface (“land”) is advantageously from 0 to 40 nm, especially from 1 to 20 nm, more especially from 2 to 10 nm, and the thickness of which in the groove, depending on the groove geometry, is advantageously from 20 to 150 nm, especially from 50 to 120 nm, more especially from 60 to 100 nm.

Suitable reflecting materials for the reflector layer are especially metals that readily reflect the laser radiation used for the recording and playback, for example metals of the third, fourth and fifth main groups and of the sub-groups of the periodic table of chemical elements. The following are especially suitable: Al, In, Sn, Pb, Sb, Bi, Cu, Ag, Au, Zn, Cd, Hg, Sc, Y, La, Ti, Zr, Hf, V, Nb, Ta, Cr, Mo, W, Fe, Co, Ni, Ru, Rh, Pd, Os, Ir, Pt and the lanthanide metals Ce, Pr, Nd, Pm, Sm, Eu, Gd, Tb, Dy, Ho, Er, Tm, Yb and Lu, as well as alloys thereof. Because of the high level of reflectivity and ease of production, preference is given especially to a reflecting layer of aluminium, silver, gold or an alloy thereof and, for economic and ecological reasons, preference is given more especially to aluminium. The reflector layer has a thickness of, advantageously, from 5 to 200 nm, especially from 10 to 100 nm, more especially from 40 to 60 nm, but thicker reflector layers are also possible, for example 1 μm thick or even more.

Suitable materials for the covering layer are mainly plastics, which are applied in a thin layer to the reflector layer either directly or with the aid of adhesion promoters. Advantageously, mechanically and thermally stable plastics having good surface properties that can still undergo modification, for example writing, are selected. The plastics can be either thermosetting or thermoplastic. For directly applied covering layers, preference is given to coatings that are radiation-cured (for example using UV radiation), which are especially simple and economical to produce. A very large number of radiation-curable materials is known. Examples of radiation-curable monomers and oligomers include acrylates and methacrylates of diols, triols and tetrols, polyimides of aromatic tetracarboxylic acids and aromatic diamines having C₁-C₄alkyl groups in at least two positions ortho to the amino groups, and oligomers having dialkylmaleinimidyl groups, for example dimethylmaleinimidyl groups. For covering layers applied by means of adhesion promoters, the same materials as are used for the substrate layer, especially polycarbonates, are preferably used. The adhesion promoters used are likewise preferably radiation-curable monomers and oligomers. Instead of the covering layer applied by means of an adhesion promoter, it is possible to use a second substrate comprising recording layer and reflector layer, with the result that the recording medium can be played on both sides. Preference is given to a symmetrical structure in which the two parts are joined to one another, on the reflector side, directly by means of an adhesion promoter, or by way of an intermediate layer.

In that form of structure, the optical properties per se of the covering layer, or of the covering materials, essentially play no part except that curing thereof may, where appropriate, be carried out by means of, for example, UV radiation. The main function of the covering layer is to ensure the mechanical strength of the recording medium as a whole and, if necessary, the mechanical strength of thin reflector layers. Where the recording medium is adequately stable, for example when a thick reflector layer is present, it may even be possible to dispense with the covering layer completely. The thickness of the covering layer depends on the thickness of the recording medium as a whole, which should preferably be a maximum of approximately 2 mm. The covering layer preferably has a thickness of from 10 μm to 1 mm.

The recording media according to the invention may also have additional layers, for example interference layers or barrier layers. It is also possible for recording media to be constructed with a plurality of (for example from two to ten) recording layers. The structure and the use of such materials are known to the person skilled in the art.

Preference is given, where appropriate, to interference layers that are arranged between the recording layer and the reflecting layer and/or between the recording layer and the substrate and that consist of a dielectric material, for example, of TiO₂, Si₃N₄, ZnS or silicone resins, as described in EP-A-0 353 393.

The recording media according to the invention can be prepared according to methods known per se, it being possible for various coating methods to be used depending on the materials employed and their mode of operation.

Suitable coating methods include, for example, immersion, pouring, brushing, knife coating, and spin-pouring, as well as vapour deposition methods, which are carried out in high vacuum. When, for example, pouring methods are used, solutions in organic solvents are generally employed. When solvents are used, it must be ensured that the supports employed are not sensitive to those solvents. Suitable coating methods and solvents are described, for example, in EP A-0 401 791.

The recording layer is preferably applied by spin-coating a dye solution, solvents that have proved especially suitable being alcohols, for example 2-methoxyethanol, isopropanol or n-butanol, hydroxyketones, for example diacetone alcohol or 3-hydroxy-3-methyl-2-butanone, hydroxy esters, for example lactic acid methyl ester or isobutyric acid methyl ester, or preferably fluorinated alcohols, for example 2,2,2-trifluoroethanol or 2,2,3,3-tetrafluoro-1-propanol, and mixtures thereof. Further suitable solvents are described, for example, in EP A-0 483 387.

The metallic reflector layer is preferably applied by atomization (sputtering) or by vapour deposition in vacuo. Those techniques are known and are described in specialised books (for example J. L. Vossen and W. Kern, “Thin Film Processes”, Academic Press, 1978). The procedures can advantageously be carried out continuously, and good reflectivity as well as a high level of adhesion of the metallic reflector layer is achieved.

The recording is carried out according to known methods by writing pits (marks) of fixed or variable length by means of a modulated, focussed laser beam guided at constant or variable speed over the surface of the recording layer. The information is read according to methods known per se by registering the variation in reflection using laser radiation, for example as described in “CD-Player und R-DAT Recorder” (Claus Biaesch-Wiepke, Vogel Buchverlag, Würzburg 1992). The requirements are known to the person skilled in the art.

The information-containing medium according to the invention is especially an optical information material of the WORM type. It can be used, for example, analogously to CD-R (compact disc-recordable) or DVD-R (digital video disc-recordable) in computers, and also as storage material for identity cards and security cards or for the manufacture of diffractive optical elements, for example holograms.

Compared with CD-R or DVD-R, however, this structure starts from a very much thinner substrate, with the result that the manufacturing procedure is considerably more tricky. In order to produce recording media having high storage density and correspondingly small pits, this has now proved to be necessary for accurate focussing.

An inverse layer structure, in which the layer sequence is substrate, reflector layer, recording layer and covering layer, is accordingly preferred. The recording layer is thus located between the reflector layer and the covering layer. Recording and playback are therefore carried out not through the substrate, but through the covering layer. Compared with the previously described structure, the respective roles of the covering layer and the substrate, especially the geometry and the optical properties, are thus reversed. A number of corresponding design arrangements are described in Proceedings SPIE-Int. Soc. Opt. Eng. 1999, 3864 for digital video recordings in conjunction with a blue GaN laser diode.

It has now been found that the inverse layer structure places substantially higher demands on the recording substances, those demands being surprisingly well met by the compounds used in accordance with invention. It is thus possible, without appreciable changes to the solid recording layer, to apply thereto a thin covering layer under which the recording substances are adequately protected from friction, photo-oxidation, finger prints, humidity and other environmental effects.

Especially preferably there is applied, to the solid recording layer and/or between the supporting material and the optical recording layer, an additional thin separating layer of a metallic, crosslinked organometallic or dielectric inorganic or organic material, for example in a thickness of from 0.001 to 10 μm, especially from 0.005 to 1 μm, more especially from 0.01 to 0.1 μm. In view of their high level of reflectivity, metallic separating layers should advantageously have a maximum thickness of 0.03 μm.

Crosslinked organometallic or dielectric inorganic layers are known per se and consist of, for example, oxides, hydrated oxides or halides (especially fluorides), metals having an electronegativity of from 1 to 2, for example aluminum, zinc, zirconium, titanium, chromium, iron, cobalt, nickel and, more especially, silicon, in a degree of oxidation of from II to V, such as CaF₂, Fe₂O₃, CoO, CoTiO₃, Cr₂O₃, Fe₂TiO, or SiO₂. They can be applied according to or analogously to known methods, for example by cathodic pulverisation, vapour deposition, chemical vapour deposition or also, for some layers, by wet-chemical methods known for that purpose, described, for example, in WO 93/08237 and in further references mentioned therein. General methods for vapour deposition, cathodic pulverisation or chemical vapour deposition are very well known to the person skilled in the art. Those methods are advantageously carried out in vacuo, the pressure during the coating procedure being from 10⁻⁸ to 10⁻¹ Pa. Metal oxides, with the exception of silicon oxides, are preferable vapour-deposited at a pressure of approximately from 10⁻³ to 2·10⁻² Pa.

Dielectric organic materials are known; for example they may be polymers.

It will be understood that further coating methods known to the person skilled in the art can also be used. For example, coatings can be prepared by the sol/gel techonology known from EP 504 926, JP-A-07/207,186, JP-A-08/175,823, JP-A-09/239,311 and JP-A-10/204296, or silicon oxide coatings can also be prepared from SiH₄ by thermal decomposition.

Silicon oxides are especially advantageously applied by vapour deposition of metallic silicon in the presence of oxygen. For vapour deposition, silicon, which need not necessarily be pure, is heated under reduced pressure in the vicinity of the substrate to be coated, in the presence of gaseous (molecular) oxygen, which also need not necessarily be pure, to a high temperature, for example from 500° C. to 2000° C., by means of induction or using an electron gun. There are formed silicon sub-oxides that are to a greater or lesser extent yellow to dark-grey coloured, or, preferably, colourless silicon dioxide, depending on the relative molar concentration of the oxygen.

It is possible, especially, for layers that are identical or analogous to the isolating layers in rewritable optical recording media based on metal alloys (CD-RW), for example those consisting of a mixture of SiO₂ and ZnS, to be applied. As a result, it is possible to speed up development and there is no need to invest anew in the coating procedure.

It may prove advantageous, prior to further coating, to treat the recording layer with an adhesion promoter, for example N-(3-(trimethoxysilyl)-propyl)pyrrole known from J. Amer. Chem. Soc. 104, 2031-4 (1982) and Chemistry of Materials 2J2, 399-402 (1997), titanium or zirconium salts, such as Ti(OiPr)₄ or Zr(acac)₄, and/or acids or bases, such as ammonia or primary, secondary or tertiary amines. Preference is given to the simultaneous use of an amine of formula 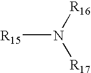
wherein R₁₅ is hydrogen or R₁₈; R₁₆ and R₁₇ are each independently of the other R₁₈; and R₁₈ is [−1,2-C₂-C₃alkylene-T-]ₙ-H wherein T is O or NH and n is a number from 1 to 3, and organometallic compounds of formula 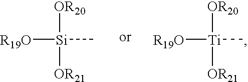
wherein R₁₉ to R₂₁ are C₁-C₄alkyl. In that case, a molar ratio of amine to organometallic compound of from 10:1 to 1000:1, a temperature of from −20 to 150° C., especially from 20 to 80° C., and a duration of treatment of from ¼ hour to 100 hours, are preferred, with special preference being given to a molar ratio of amine to organometallic compound of from 50:1 to 250:1, a temperature of from 50 to 80° C. and a duration of treatment of from 1 to 10 hours.

If desired, such coatings can, for example, be applied in the same thickness also between the supporting material and the metallic reflector layer, or between the metallic reflector layer and the optical recording layer. In some cases this can lead to advantages, for example when a silver reflector is used in combination with sulfur-containing additives in the recording layer.

Instead of or also in addition to inorganic or crosslinked organometallic layers, it is also possible to use layers of a polymer, which are applied, for example, by polymerisation, especially by photopolymerisation, or alternatively by lamination.

Especially advantageously, there may be applied by polymerisation or lamination, over the inorganic or crosslinked organometallic layer, a covering layer having the thickness and optical properties disclosed hereinabove.

The invention accordingly relates also to an optical recording medium comprising, in the following arrangement,
(a) a supporting material consisting of a reflecting metal or, preferably, of a polymer having a reflecting metallic layer;
(b) an optical recording layer comprising a compound of formula (I), (II), (III), (IV) or (V);
(c) a separating layer consisting of a metallic, crosslinked organometallic or dielectric inorganic or organic substance; and
(d) a covering layer.

Most of the compounds used in accordance with the invention are known or can be prepared analogously to known compounds according to known processes, for example those disclosed or referred to in Liebigs Ann. Chem 647, 11 (1961), Liebigs Ann. Chem 663, 96 (1963), Chimia 20, 318-323 (1966), J. Indian Chem. Soc. 47/12, 1121-1128 (1970), U.S. Pat. No. 3,850,645, Liebigs Ann. Chem 1975, 373-386 (1975), Bull. Chem. Soc. Japan 51/2, 535-539 (1978) or Helv. Chem. Acta 67/3, 770-773 (1984).

It is also possible, however, in accordance with or analogously to the same processes known per se, to prepare novel compounds that can be used in accordance with the invention in optical recording media.

The invention accordingly relates also to compounds of formula (I), (II), (III), (IV) or (V), with the exception of the compounds that are already known.

The following Examples illustrate the invention without limiting the scope thereof (unless indicated otherwise, “%” is always % by weight):

### EXAMPLE 1

3.00 g of N-ethyl-3-cyano-4-methyl-5-(methylene-dimethylamino)-6-hydroxy-2-pyridone are stirred together with 2.28 g of 2,6-diisopropylaniline in 100 ml of ethanol and heating under reflux is carried out for 2 hours. The greenish-yellow solution is concentrated by evaporation to approximately ⅓ and, after cooling, the precipitate is filtered off with suction, washed twice with 20 ml of methanol each time, and dried at 60° C./1.2·10⁴ Pa.

3.41 g of a pale-yellowish product of formula: 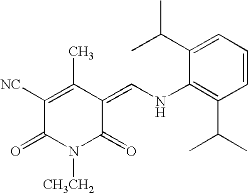
are obtained.

Absorption: λₘₐₓ (DMF=dimethylformamide)=367.6 nm; ε=42238.

### EXAMPLE 2

4.00 g of N-ethyl-3-cyano-4-methyl-6-hydroxy-2-pyridone is stirred together with 3.3.3 g of triethyl orthoformate, 3.77 g of 2-methoxy-4-nitroaniline and 100 ml of acetic acid (100%), and boiling under reflux is then carried out for 2½ hours. After cooling, the precipitate is filtered off with suction, washed with ethanol and dried at 60° C./1.2·10⁴ Pa. 5.40 g of yellow product of formula 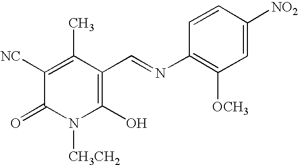
are obtained.

Absorption: λₘₐₓ (DMF)=439 nm; ε=50363.

### EXAMPLES 3-50

Analogously to Examples 1 and 2, the following compounds are obtained in a good yield and a good level of purity (optical data in each case in DMF):

| Example | Formula | R₁ | R₅ or R₆ | λₘₐₓ | ε |
|---|---|---|---|---|---|
| 3 | (VI) | CH₂CH₃ | 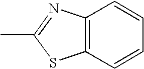 | 404.6 | 48650 |
| 4 | (VI) | CH₂CH₃ | 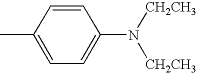 | 449.9 | 36062 |
| 5 | (VI) | CH₂CH₃ | 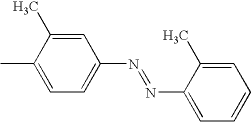 | 428.2 | 52885 |
| 6 | (VII) | CH₂CH₃ | 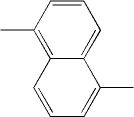 | 419.0 | |
| 7 | (VI) | CH₂CH₃ | 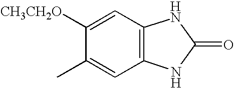 | 434.9 | 38022 |
| 8 | (VI) | CH₂CH₃ | 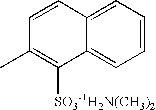 | 405.3 | 49757 |
| 9 | (VI) | CH₂CH₃ | 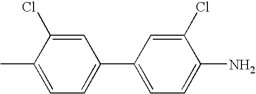 | 418.8 | 50171 |
| 10 | (VII) | CH₂CH₃ | 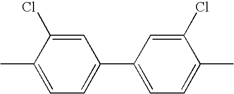 | 423.5 | 75541 |
| 11 | (VII) | CH₂CH₃ | 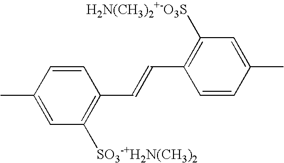 | 444.6 | 68578 |
| 12 | (VI) | CH₂CH₃ | 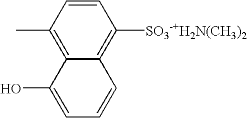 | 434.3 | 32480 |
| 13 | (VII) | CH₂CH₃ | 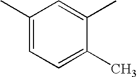 | 409.7 | 82265 |
| 14 | (VII) | CH₂CH₃ | 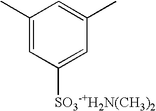 | 398.5 | 68355 |
| 15 | (VI) | CH₂CH₃ | 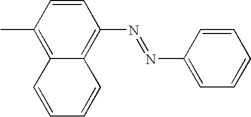 | 471.8 | 32076 |
| 16 | (VI) | CH₂CH₃ | 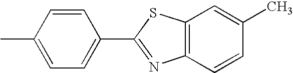 | 414.9 | 56204 |
| 17 | (VI) | CH₂CH₃ | 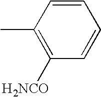 | 395.7 | 46450 |
| 18 | (VI) | CH₂CH₃ | 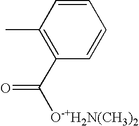 | 400.6 | 37253 |
| 19 | (VI) | CH₂CH₃ | 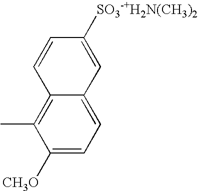 | 392.2 | 26946 |
| 20 | (VII) | CH₂CH₃ | 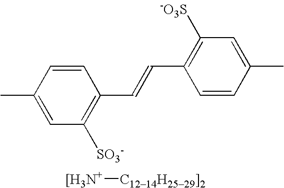 | 443.0 | 89620 |
| 21 | (VI) | CH₂CH₃ | 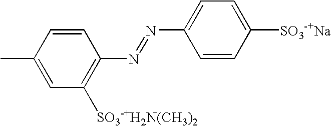 | 425.7 | 53864 |
| 22 | (VI) | CH₂CH₃ | 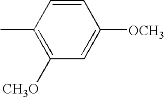 | 414.5 | 43633 |
| 23 | (VI) | CH₂CH₃ | 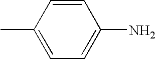 | 432.8 | 63718 |
| 24 | (VI) | CH₂CH₃ | 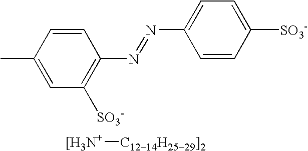 | 420.0 | 48637 |
| 25 | (VII) | CH₂CH₃ | 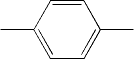 | 442.0 | 75861 |
| 26 | (VII) | CH₂CH₃ | 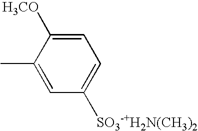 | 404.0 | 46169 |
| 27 | (VI) | CH₂CH₃ | 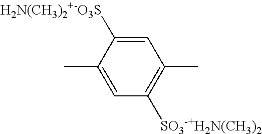 | 439.3 | 90932 |
| 28 | (VII) | CH₂CH₃ | 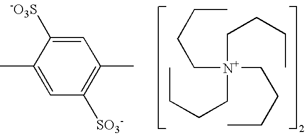 | 439.0 | 82103 |
| 29 | (VII) | CH₂CH₃ | 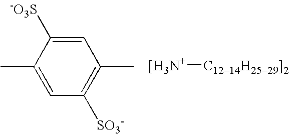 | 439.2 | 90598 |
| 30 | (VI) | CH₂CH₃ | 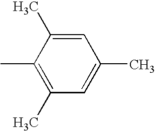 | 368.9 | 41352 |
| 31 | (VI) | CH₂CH₃ | 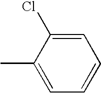 | 391.3 | 45210 |
| 32 | (VI) | CH₂CH₃ | 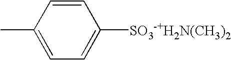 | 395.5 | 48072 |
| 33 | (VI) | CH₂CH₃ | 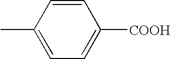 | 396.5 | 51492 |
| 34 | (VI) | CH₂CH₃ | 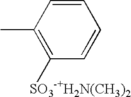 | 392.4 | 48443 |
| 35 | (VI) | CH₂CH₃ | 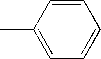 | 390.7 | 44112 |
| 36 | (VI) | CH₂CH₃ | 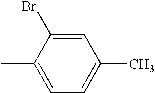 | 394.9 | 43017 |
| 37 | (VI) | CH₂CH₃ | 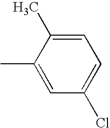 | 393.1 | 43047 |
| 38 | (VI) | CH₂CH₃ | 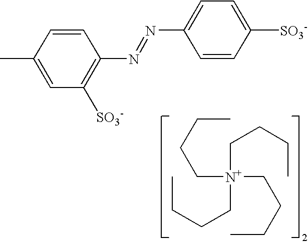 | 428.0 | 57936 |
| 39 | (VI) | CH₂CH₃ | 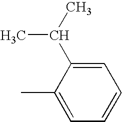 | 388.6 | 39414 |
| 40 | (VI) | CH₂CH₃ | 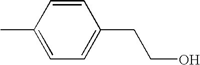 | 394.0 | 47243 |
| 41 | (VI) | CH₂CH₃ | 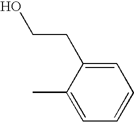 | 386.5 | 42284 |
| 42 | (VI) | CH₂CH₃ | 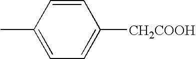 | 392.2 | 44365 |
| 43 | (VI) | CH₂CH₃ | 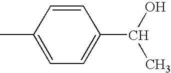 | 393 | 42749 |
| 44 | (VI) | CH₂CH₃ | 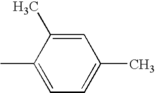 | 395.1 | 44004 |
| 45 | (VI) | CH₂CH₃ | 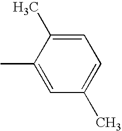 | 394.1 | 43021 |
| 46 | (VI) | CH₂CH₃ | 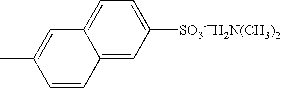 | 406.1 | 50074 |
| 47 | (VI) | CH₂CH₃ | 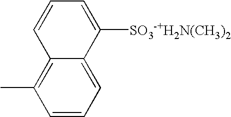 | 404 | 35033 |
| 48 | (VI) | CH₂CH₃ | 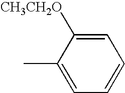 | 405 | 43008 |
| 49 | (VI) | CH₂CH₃ | 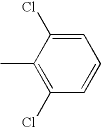 | 370.1 | 40083 |
| 50 | (VI) | CH₂CH₃ | 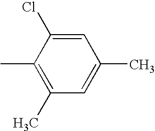 | 370.4 | 39123 |

### EXAMPLES 51-53

1.56 mmol of the compound according to Example 1 are dissolved in 50 ml of dimethylformamide and 0.78 mmol of copper(II) acetate is added. The solution is stirred for 4 hours at 50° C. and then cooled. The product is precipitated with water. By proceeding analogously thereto with the compounds according to Examples 30 and 48 instead of the compound according to Example 1, compounds according to formula (IV) are obtained in a good yield and a good level of purity (optical data in each case in DMF):

| Example | Formula | R₁ | M′ | R₅ or R₆ | λₘₐₓ | ε |
|---|---|---|---|---|---|---|
| 51 | (VIII) | CH₂CH₃ | Cu | 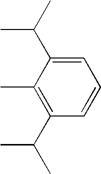 | 356.8 | 73369 |
| 52 | (VIII) | CH₂CH₃ | Cu | 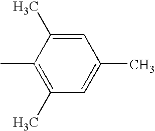 | 355.5 | 86444 |
| 53 | (VIII) | CH₂CH₃ | Cu | 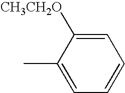 | 369.1 | 63665 |

### COMPARISON EXAMPLES 1-3

Analogously to the Examples according to the invention, wing compounds corresponding to Examples 26 and 27 of JP-A-11/34500 are (optical data in each case in DMF):

| Comparison | | | |
|---|---|---|---|
| Example | Formula | λₘₐₓ | ε |
| 1 | 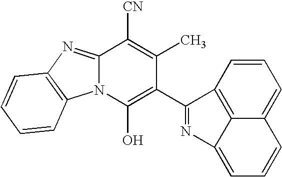 | 588.12 | 7953 |
| 2 | 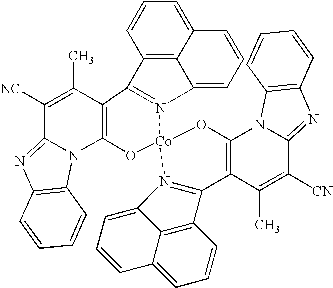 | 529 | 13826 |
| 3 | 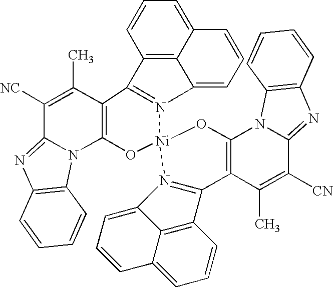 | 524.4 | 15518 |

### EXAMPLES 54-56

The procedure is analogous to Examples 51-53, except that 0.78 mmol of nickel(II) acetate is used instead of copper(II) acetate.

### EXAMPLES 57-59

The procedure is analogous to Examples 51-53, except that 0.52 mmol of cobalt(II) acetate is used instead of copper(II) acetate and air is then passed through the solution. Compounds according to formula (V) are obtained wherein M is Co(M).

### EXAMPLE 60

1.5% of compound according to Example 1 is dissolved in 2,2,3,3-tetrafluoro-1-propanol and the solution is filtered through a 0.2 mm Teflon filter. The dye solution is then applied by the spin-coating method at 250 revs/min to a 0.6 mm thick grooved polycarbonate disc (diameter 120 mm, groove spacing 0.74 μm, groove depth 170 nm, groove width 340 nm) and the speed is increased to 1500 revs/min so that excess solution is spun off and a uniform solid layer is formed. After drying, the solid layer has an absorbance of 0.68 at 368 nm. In a vacuum coating apparatus (Twister™, Balzers Unaxis), a 65 nm thick reflection layer of silver is then applied. A UV cross-linkable photopolymer (DSM 650-020) is then applied in a thickness of 5 μm by spin coating and is crosslinked using UV light. At 405 nm the recording layer has a reflectivity of 49%. Using a pulsed dye laser (15 ns pulse length), pits are written into the recording layer at a wavelength of 405 nm with an energy density of 0.5 kJ/m², resulting in a change in reflectivity from 49% to 22% at the written sites.

### EXAMPLES 61-118

The procedure is analogous to Example 60, except that the compound according to Example 1 is replaced by the compounds according to Examples 2 to 59.

1. An optical recording medium, comprising a substrate, a recording layer and a reflecting layer, wherein the recording layer comprises a compound of formula 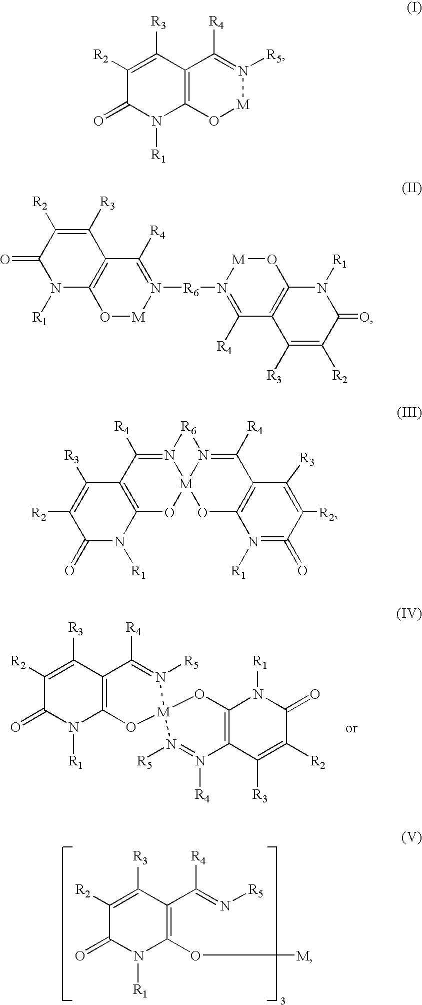
or a tautomer or a salt thereof, optionally in ionised form in the form of a salt neutralised with a counter-ion,
wherein
R₁ is hydrogen or is C₁-C₂₄alkyl, C₁-C₄alkyl-[O—C₂-C₄alkylene]ₘ, C₁-C₄alkyl-[NH—C₂-C₄alkylene]ₘ, C₂-C₂₄alkenyl, C₃-C₂₄cycloalkyl, C₃-C₂₄cycloalkenyl, C₆-C₁₂aryl, C₄-C₁₂heteroaryl or C₇-C₁₂aralkyl each of which is unsubstituted or substituted by one or more optionally identical or different R₇ radicals;
R₂ and R₃ are each independently of the other hydrogen, NO₂, CO—R₈, COOH, COOR₈, CONR₉R₁₀, CN, SO₃R₈ or SO₂NR₉R₁₀, or C₁-C₂₄alkyl, C₁-C₄alkyl-[O—C₂-C₄alkylene]ₘ, C₁-C₄alkyl-[NH—C₂-C₄alkylene]ₘ, C₂-C₂₄alkenyl, C₃-C₂₄cycloalkyl, C₃-C₂₄cycloalkenyl, C₆-C₁₂aryl, C₄-C₁₂heteroaryl or C₇-C₁₂aralkyl each of which is unsubstituted or substituted by one or more optionally identical or different R₇ radicals;
it being possible for R₃ to be so linked to R₂ that a 5- or 6-membered ring is formed;
R₄ is hydrogen or is C₁-C₂₄alkyl, C₁-C₄alkyl-[O—C₂-C₄alkylene]ₘ, C₁-C₄alkyl-[NH—C₂-C₄alkylene]ₘ, C₂-C₂₄alkenyl, C₃-C₂₄cycloalkyl, C₃-C₂₄cycloalkenyl, C₆-C₁₂aryl, C₄-C₁₂heteroaryl or C₇-C₁₂aralkyl each of which is unsubstituted or substituted by one or more optionally identical or different R₇ radicals; it being possible for R₄ to be so linked to R₃ that a 5- or 6-membered ring is formed;
R₅ is R₆H, C₆-C₁₂aryl, C₄-C₁₂heteroaryl or C₇-C₁₂aralkyl each of which is unsubstituted or substituted by one or more optionally identical or different R₇ radicals;
it being possible for R₅ to be so linked to R₄ that a 5- or 6-membered ring is formed;
R₆ is a group selected from the series consisting of —N═N—, —O—, —S—, —SO₂—, —CH═N—, and of 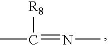
C₁-C₂₄alkylene, C₁-C₄alkylene-[O—C₂-C₄alkylene]ₘ, C₁-C₄alkylene-[NH—C₂-C₄alkylene]ₘ, C₂-C₂₄alkenylene, C₃-C₂₄cycloalkylene, C₃-C₂₄cycloalkenylene, C₆-C₁₂arylene, C₄-C₁₂heteroarylene and C₇-C₁₂aralkylene each of which is unsubstituted or substituted by one or more optionally identical or different R₇ radicals; or is a sequence of a plurality of such groups; R₇, and where appropriate a plurality of R₇ radicals, each independently of any other, is halogen, OH, O—R₈, O—CO—R₈, S—R₈, NH₂, NH—R₈, NR₉R₁₀, NR₈—CO—R₉, NR₉COOR₈, CHO, carboxy, carbamoyl, ureido, NR₉—CO—NHR₁₀, phosphato, PR₉R₁₀, POR₈OR₉, P(═O)OR₈OR₉, OPR₈R₉, OPR₈OR₉, OP(═O)R₈OR₉, OP(═O)OR₈OR₉, OPO₃R₈, sulfato, sulfo, NO₂, CO—R₈, COOH, COOR₈, CONR₉R₁₀, CN, SO₃R₈ or SO₂NR₉R₁₀, or is C₁-C₁₂alkyl unsubstituted or mono- or poly-substituted by hydroxy, CO—R₈, COOH, COOR₈, CONR₉R₁₀ or by halogen;
R₈, R₉ and R₁₀ are each independently of the others C₁-C₁₂alkyl, C₂-C₁₂alkenyl, C₆-C₁₂aryl, C₄-C₁₂heteroaryl or C₇-C₁₂aralkyl; or
R₉ and R₁₀, together with the common nitrogen, are unsubstituted or with C₁-C₄alkyl mono- to tetra-substituted pyrrolidine, piperidine, piperazine or morpholine;
m is a number from 1 to 10; and
M is hydrogen or an alkali metal, alkaline earth metal or transition metal that may or may not have one or more ligands.

2. An optical recording medium according to claim 1 comprising a compound of formula (I), (II), (III), (IV) or (V) wherein R₁ is unsubstituted or monosubstituted C₁-C₁₂alkyl, R₂ is COOR₈, CONR₉R₁₀ or CN, R₃ is hydrogen or C₁-C₄alkyl, R₄ is C₁-C₄alkyl or hydrogen, and/or R₅ is C₆-C₁₂aryl unsubstituted or substituted by one or more optionally identical or different R₇ radicals.

3. An optical recording medium according to claim 1 2 comprising a compound of formula (I), (II), (III), (IV) or (V) wherein R₁ is C₁-C₄alkyl, R₂ is CN, R₃ is methyl and R₄ is hydrogen.

4. An optical recording medium according to claim 1, wherein the reflecting layer consists of aluminium, silver, gold or an alloy thereof.

5. A method of recording or playing back data, which comprises recording or playing back the data on an optical recording medium according to claim 1 at a wavelength of from 350 to 500 nm.

6. An optical recording medium comprising, in the following arrangement:
(a) a supporting material consisting of a reflecting metal or of a polymer having a reflecting metallic layer;
(b) an optical recording layer comprising a compound of formula (I), (II), (III), (IV) or (V) as defined in claim 1;
(c) a separating layer consisting of a metallic, crosslinked organometallic or dielectric inorganic or organic substance; and
(d) a covering layer.

7. A method of recording or playing back data, which comprises recording or playing back the data on an optical recording medium according to claim 6 at a wavelength of from 350 to 500 nm.

8. A compound of formula (I) as defined in claim 1, with the proviso that R₁ is not hydrogen.

9. A compound of formula (II) or (III) as defined in claim 1, with the proviso that R₆ is not an aromatic group.

10. A compound of formula (IV) or (V) as defined in claim 1.

11. (canceled).

12. An optical recording medium comprising a substrate, a recording layer and a reflecting layer, wherein the optical recording medium is suitable for recording or playing back in the wave range from 380 to 440 nm and the recording layer comprises a compound having an absorption maximum in the wave range from 300 to 400 nm and also a compound of formula 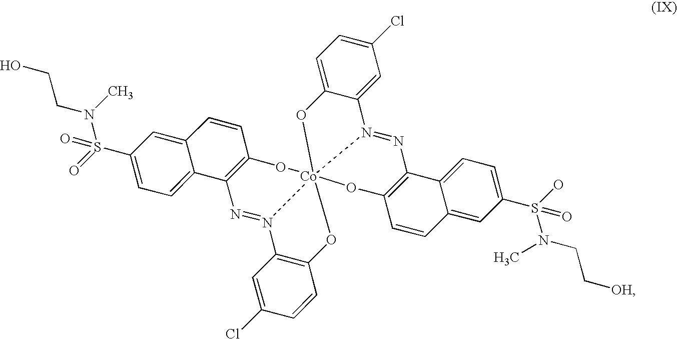
which may be unsubstituted or substituted and/or may be in isomeric form.
